(19) United States
(12) Patent Application Publication
(10) Pub. No.: US 2014/0153891 A1
(43) Pub. Date: Jun. 5, 2014

(54) FIBER OPTIC DISTRIBUTION DEVICE

(71) Applicant: CCS Technology, Inc., Wilmington, DE (US)

(72) Inventors: Tomasz Andrzej Ciechomski, Lowicz (PL); Michal Ruda, Lodz (PL)

(73) Assignee: CCS Technology, Inc., Wilmington, DE (US)

(21) Appl. No.: 14/093,636

(22) Filed: Dec. 2, 2013

(30) Foreign Application Priority Data
Dec. 3, 2012 (EP) 12195300.4

(51) Int. Cl. G02B 6/44

(52) U.S. Cl. CPC G02B 6/4452
USPC 385/135

(57) ABSTRACT

A fiber optic distribution device for handling optical fibers, especially wall box, is disclosed. The fiber optic distribution device includes housing with a back wall having parallel grooves, a front wall and side walls defining together an interior of the housing. Fiber optic management units like patch units and/or splice units and/or overlength units for handling optical fibers and/or junctions between optical fibers mount in the interior of the housing to the back wall. The back wall has at least one set of parallel grooves, whereby each fiber optic management unit is mounted to the back wall by fastening elements acting together with at least one of grooves.

### RELATED APPLICATIONS

This application claims the benefit of priority under 35 U.S.C. §119 of European Patent Application Serial No. 12195300.4 filed on Dec. 3, 2012, the content of which is relied upon and incorporated herein by reference in its entirety.

### BACKGROUND

1. Field of the Disclosure

The present patent application relates to a fiber optic distribution device and, particularly to a fiber optic distribution device with components mounted therein.

2. Technical Background

When designing data transmission networks comprising optical fibers, it is necessary to handle optical fibers, especially to connect optical fibers to one another. Junctions between optical fibers can be provided by patch connections and splice connections. Such junctions need to be handled both outside buildings and inside buildings. Outside buildings, junctions between optical fibers are accommodated in so called cable sleeves or street cabinets. Inside buildings, junctions between optical fibers are handled in so called distribution cabinets or distribution frames. So called wall boxes are used for the handling of junctions between optical fibers both outside buildings and inside buildings.

FIG. 1 shows a schematic view of a conventional fiber optic distribution device 10 having a housing 11 and designed as a wall box. The housing 11 of fiber optic distribution device 10 of FIG. 1 comprises a back wall 12, a front wall (not shown) and side walls 13, 14, 15 and 16 defining together an interior 17 of the housing 11. The fiber optic distribution device 10 further comprises fiber optic management units (not shown) like patch units and/or splice units and/or overlength units for handling optical fibers and/or junctions between optical fibers, wherein the fiber optic management units are positioned in the interior 17 of the housing 11. The fiber optic management units are mounted to the back wall 12 of the housing 11 by screws acting together with holes 18 in the back wall 12 of the housing 11. The holes 18 are arranged in an array, whereby the holes 18 provide fixed installation positions or mounting positions for fiber optic management units at the back wall 12 of the housing 11.

The present application is based on the problem of providing a novel fiber optic distribution device suitable for handling optical fibers both outside buildings and inside buildings, the fiber optic distribution device providing flexible installation positions or mounting positions for fiber optic management units.

### SUMMARY

Embodiments disclosed herein relate to a fiber optic distribution device having a housing with a back wall. The back wall of the housing comprises at least one set of parallel grooves, whereby each fiber optic management unit is mounted to the back wall by fastening elements acting together with at least one of grooves. The grooves provide flexible installation positions or mounting positions for fiber optic management units at the back wall of the housing of the fiber optic distribution device. In this way, mounting fiber optic management units in the fiber optic distribution device is simple, reliable and cost-effective.

The back wall may comprise one set of parallel grooves all running the same direction. Alternatively, the back wall may comprise a first set of parallel grooves running in a first direction and a second set of parallel grooves running in a second direction, wherein the first set of parallel grooves is intersecting the second set of parallel grooves. Both alternatives are simple, reliable, cost-effective and provide an increased flexibility of installation positions or mounting positions for fiber optic management units at the back wall of the housing of the fiber optic distribution device.

Each fiber optic management unit may be mounted to the back wall by screws cutting into the respective groove. This further development is very simple, reliable and cost-effective.

According to another embodiment, each fiber optic management unit may be mounted to the back wall by snap hooks snapping into the respective groove. This allows a simple, reliable and cost-effective installation.

### BRIEF DESCRIPTION OF THE FIGURES

Embodiments of the fiber optic distribution device are given in the description below. Exemplary embodiments will be explained in more detail with reference to the drawing, in which:

FIG. 1 shows a top view of a conventional fiber optic distribution device showing a housing with a removed front wall;

FIG. 2 shows a top view of a housing of a fiber optic distribution device according to the present application with a removed front wall of the housing;

FIG. 3 shows a top view of FIG. 1 with several fiber optic management units mounted on the back wall of the housing.

FIG. 4 shows the cross-section of FIG. 3;

FIG. 5 shows the detail of FIG. 4;

FIG. 6 shows another top view of FIG. 1 with several fiber optic management units mounted on the back wall of the housing;

FIG. 7 shows another top view of FIG. 1 with one fiber optic management unit mounted on the back wall of the housing; and

FIG. 8 shows a top view of another housing of a fiber optic distribution device according to the present application with a removed front wall of the housing.

### DETAILED DESCRIPTION

The present patent application relates to a fiber optic distribution device 20, preferably to a wall box. The fiber optic distribution device 20 comprises a housing 21. The housing 21 comprises a back wall 22, a front wall (not shown) and side walls 23, 24, 25 and 26 defining together an interior 27 of the housing 21. The fiber optic distribution device 20 further comprises fiber optic management units for handling optical fibers and/or junctions between optical fibers being positioned in the interior 27 of the housing 21.

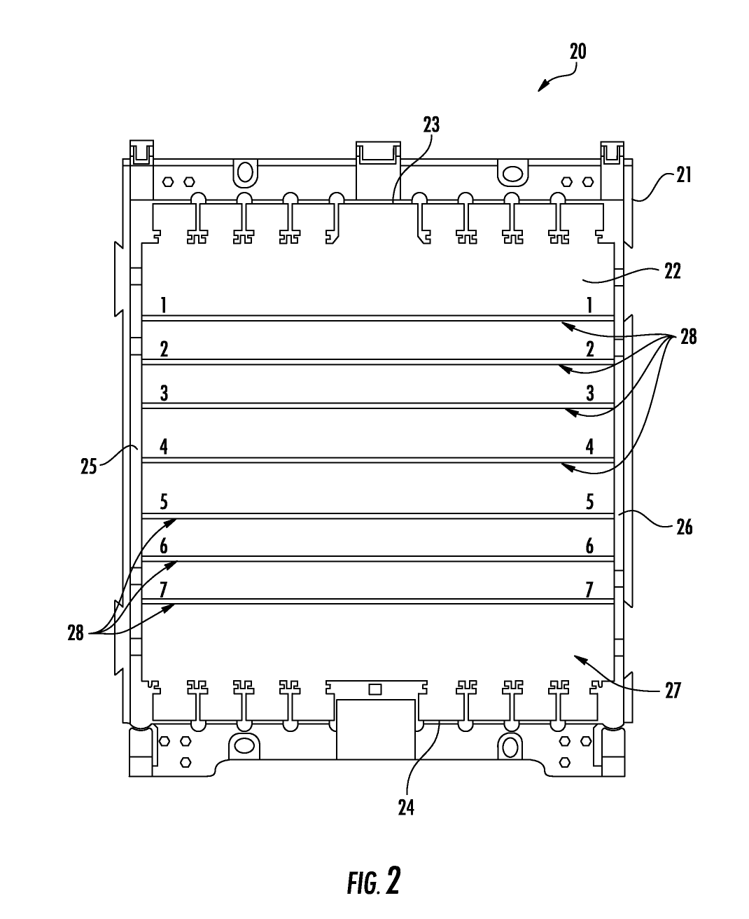

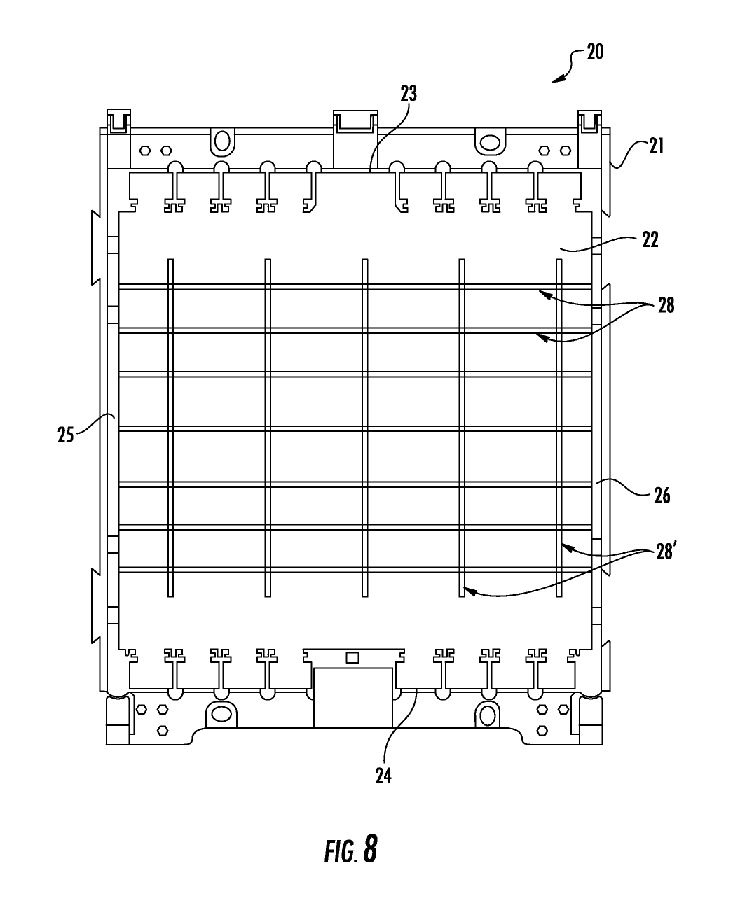

The fiber optic management units are mounted to the back wall 22 of the housing 21 by fastening elements acting together with grooves 28 (see FIGS. 2, 7) in the back wall 22 of the housing 21. The back wall 22 comprises at least one set of parallel grooves 28, wherein each fiber optic management unit is mounted to the back wall 22 by fastening elements acting together with at least one of the grooves 28.

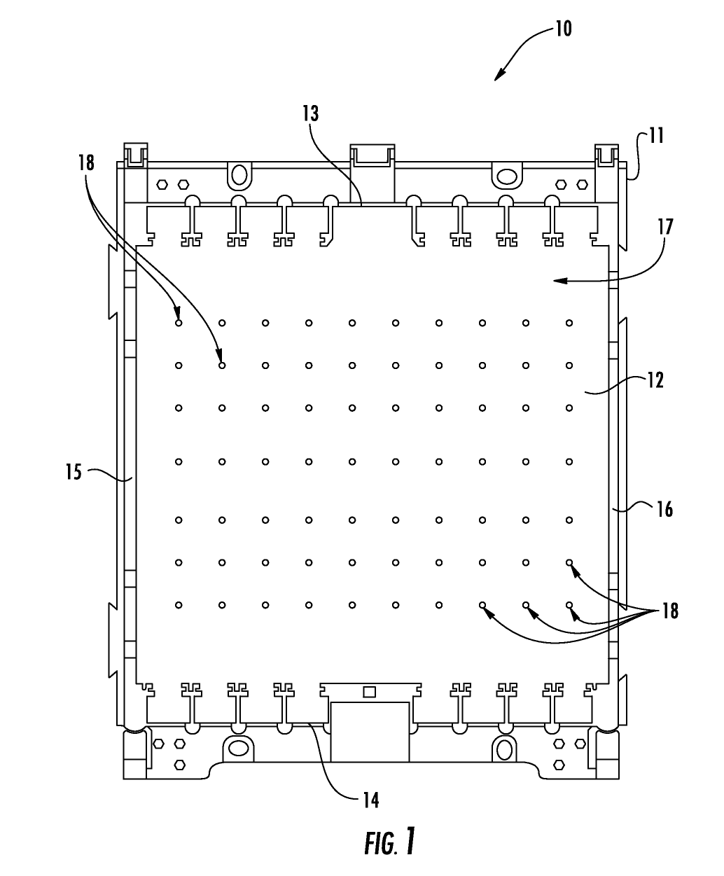

In the embodiment shown in FIGS. 1 to 7, the back wall 22 of the housing 21 comprises one set of seven (7) parallel grooves 28 all miming in horizontal direction (see FIGS. 2, 7). Alternatively, the set of parallel grooves 28 could all run in vertical direction.

According to another embodiment (see FIG. 8), the back wall 22 of the housing 21 may comprise a first set of parallel grooves 28 running in a first direction and a second set of parallel grooves 28′ running in a second direction, wherein the first set of parallel grooves 28 is intersecting the second set of parallel grooves 28′.

The first set of parallel grooves 28 may run in horizontal direction and that the second set of parallel grooves 28′ vertical may run in horizontal direction (see FIG. 8).

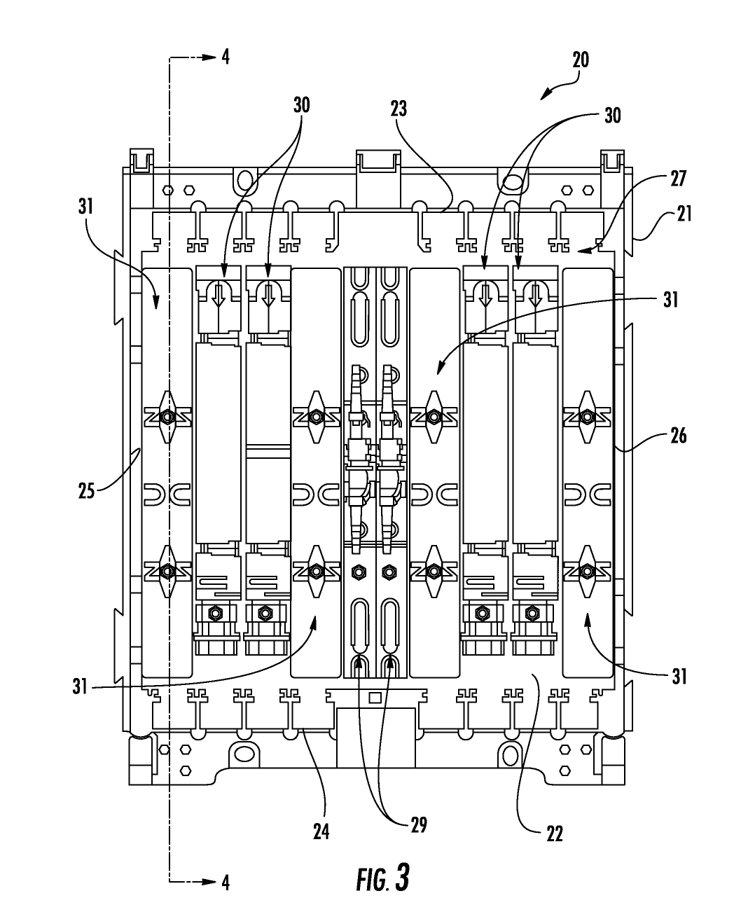

FIG. 3 shows the housing 21 of the fiber optic distribution device 20 together with different fiber optic management units 29, 30, 31 mounted to the back wall 22 by fastening elements acting together with at least one of grooves 28.

The fiber optic management units 29 are designed as patch units for handling patch connections between optical fibers. The fiber optic management units 30 are designed as splice units for handling splice connections between optical fibers. The fiber optic management units 31 are designed as routing units for routing optical fibers between the fiber optic management units 29, 30. Several stacked fiber optic management units 31 may provide an overlength unit for handling overlength of optical fibers.

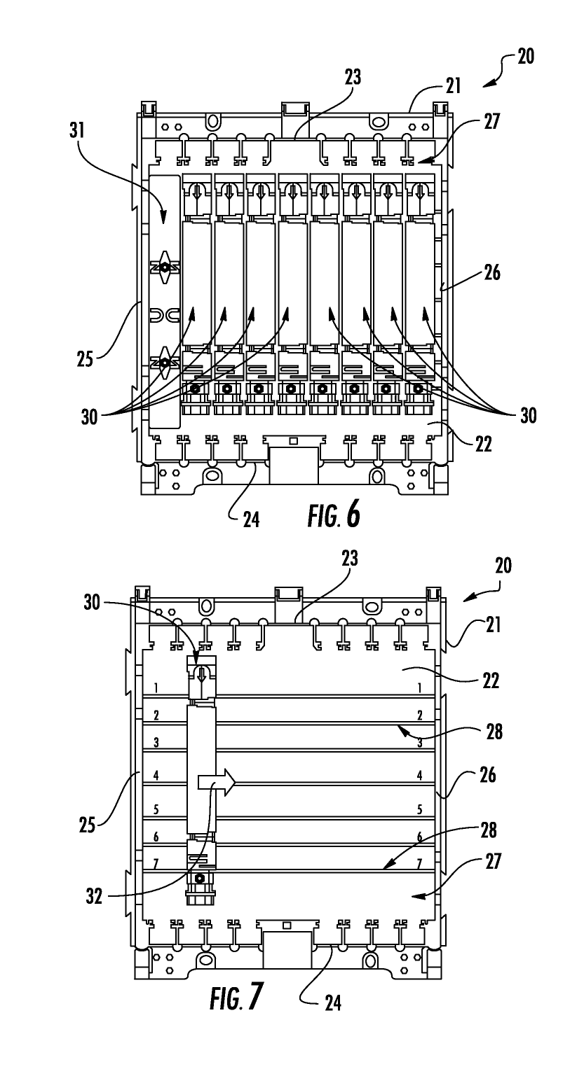

FIG. 6 shows the housing 21 of the fiber optic distribution device 20 together with eight (8) fiber optic management units 30 designed as splice units and one (1) fiber optic management units 31 designed as routing unit.

FIG. 7 shows the housing 21 of the fiber optic distribution device 20 together with one (1) fiber optic management unit 30 designed as splice unit, wherein by the arrow 32 illustrates that the mounting position of fiber optic management unit 30 at the back wall 22 of the housing 21 is flexible along the direction of the parallel grooves.

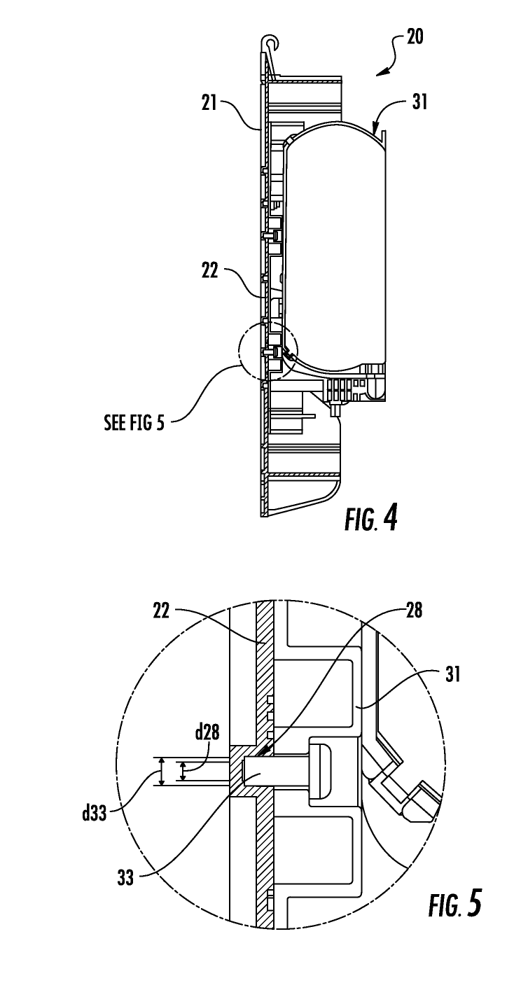

As mentioned above, each fiber optic management unit 29, 30, 31 is mounted to the back wall 22 of the housing 21 by fastening elements acting together with at least one of the grooves 28 in the back wall 22 of the housing 21. In the shown embodiment (see FIGS. 4 and 5), each fiber optic management unit 29, 30, 31 is mounted to the back wall 22 by screws 33 cutting into the respective groove 28, namely into the material of the back wall 22 in the region of the respective groove 28. The outer diameter d33 (see FIG. 5) of the screws 33 is larger than the respective dimension d28 (see FIG. 5) of the groove 28 so that the respective screw 33 cuts into the material of the back wall 22 in the region of the respective groove 28.

By disengaging the screws 33 from the back wall 22, the position of the respective fiber optic management unit 29, 30, 31 can be changed along the groove 28 in a continuous manner.

Alternatively, each fiber optic management unit 29, 30, 31 may be mounted to the back wall 22 by snap hooks snapping into the respective groove 28. The shape of the groove may be modified for such a snap hooks connection.

In this way, fiber optic management units 29, 30, 31 may be installed in the fiber optic distribution device 10 in different positions along groove 28 in the back wall 22 of the housing 21 of the fiber optic distribution device 10. Additionally, the fiber optic distribution device 10 is modular and scalable.

Many modifications and other embodiments set forth herein will come to mind to one skilled in the art to which the embodiments pertain having the benefit of the teachings presented in the foregoing descriptions and the associated drawings. Therefore, it is to be understood that the description and claims are not to be limited to the specific embodiments disclosed and that modifications and other embodiments are intended to be included within the scope of the appended claims. It is intended that the embodiments cover the modifications and variations of the embodiments provided they come within the scope of the appended claims and their equivalents. Although specific terms are employed herein, they are used in a generic and descriptive sense only and not for purposes of limitation.

What is claimed is:

1. A fiber optic distribution device for handling optical fibers, especially wall box, the fiber optic distribution device comprises:
a housing with a back wall, a front wall and side walls defining together an interior of the housing; and
parallel grooves formed in the back wall for flexibly mounting along the direction of the parallel grooves fiber optic management units using fastening elements.

2. The fiber optic distribution device of claim 1, wherein the fiber optic management units are positioned in the interior of the housing.

3. The fiber optic distribution device of claim 1, wherein the fiber optic management units comprise at least one of patch units, splice units and overlength units.

4. The fiber optic distribution device of claim 1, comprising one set of parallel grooves.

5. The fiber optic distribution device of claim 1, wherein the grooves run in vertical direction.

6. The fiber optic distribution device of claim 1, wherein the grooves run in horizontal direction.

7. The fiber optic distribution device of claim 1, wherein the parallel grooves comprise a first set of parallel grooves running in a first direction and a second set of parallel grooves running in a second direction.

8. The fiber optic distribution device of claim 7, wherein the first set of parallel grooves intersects the second set of parallel grooves.

9. The fiber optic distribution device of claim 8, wherein the first set of parallel grooves run in horizontal direction and that the second set of parallel grooves in vertical direction.
